(19) United States
(12) Patent Application Publication
(10) Pub. No.: US 2013/0022426 A1
(43) Pub. Date: Jan. 24, 2013

(54) SCREW

(71) Applicant: KENG SHUI WU, Tainan City (TW)

(72) Inventor: KENG SHUI WU, Tainan City (TW)

(73) Assignee: YIH SHWEI BOLT INDUSTRIAL CO., LTD., Tainan City (TW)

(21) Appl. No.: 13/186,119

(22) Filed: Jul. 19, 2011

(51) Int. Cl. F16B 39/28

(52) U.S. Cl. 411/337

(57) ABSTRACT

A screw includes a head and a shank combined together. The head is formed with a circumference provided thereon with continuously arranged point-shaped ribs. When the circumference of the head is being locked into a wood piece, the ribs will function to carry out excavating to enable the screw to be locked into the wood piece comparatively easily.

### BACKGROUND OF THE INVENTION

1. Field of the Invention

This invention relates to a screw, particularly to one having the circumference of a head provided thereon with continuously arranged ribs, able to lower locking resistance for enabling the screw to be quickly locked into a wood piece.

2. Description of the Prior Art

A conventional screw 1, as shown in FIG. 1, is composed of a head 10 and a shank 11. The head 10 is provided with a circumference 100 that is taper-shaped or arc-shaped and has its surface provided thereon with a plurality of ribs 12 distributed matching the shape of the circumference 100. The ribs 12 are respectively formed linearly, that is, each rib 12 is connected into a line from an uppermost end 120 to a lowermost end 121, but the linear ribs 12 can be curved for matching the shape of the circumference 100 or the spiral threads of the shank 11. The shank 11 of the screw 1 is provided with threads 110 and a cutting blade 111.

That the ribs 12 of a conventional screw 1 are made into a linear state may be in view the convenience of the forging process of the head 10; nevertheless, the linear ribs 12 are linear projections formed on the circumference 100 of the head 10. Therefore, although able to excavate a wood piece and advantageous to locking in a wood locking process, yet, the linear ribs 12 will also cause surface resistance. That is to say, when the head 10 of the screw 1 is being locked and embedded into a wood piece (A), the linear ribs 12 will contact with the hole wall AO of the wood piece (A), as shown in FIG. 3, and produce too large a locking resistance, thus failing to smoothly carry out locking of a screw and hence lowering locking velocity.

### SUMMARY OF THE INVENTION

The objective of this invention is to offer a screw, able to lower resistance when the screw is being locked into a wood piece for enabling the screw to carry out locking smoothly and quickly.

The screw in the present invention has the circumference of a head provided thereon with continuously arranged dot-shaped ribs for carrying out point contact, not surface contact, between the ribs and the walls of excavated holes of a wood piece, able to lower locking resistance.

The circumference of the head of this invention is provided with a plurality of ribs formed matching with the shape of the circumference.

### BRIEF DESCRIPTION OF DRAWINGS

This invention will be better understood by referring to the accompanying drawings, wherein:

FIG. 1 is a front view of a conventional screw;

FIG. 2 is a cross-sectional view of the line A-A in FIG. 1;

FIG. 3 is a schematic view of the conventional screw locked into a wood piece;

FIG. 4 is a front view of a screw in the present invention, applied to a wood screw;

FIG. 5 is a cross-sectional view of the line B-B in FIG. 4;

FIGS. 5A-5E are schematic views illustrating various preferred embodiments of ribs in the present invention;

FIG. 6 is a cross-sectional view of a head of the wood screw in the present invention;

FIGS. 6A-6C are cross-sectional views of various preferred embodiments of a rib member in the present invention;

FIG. 7 is a front view of a screw in the present invention, applied to a self-tapping screw; and

FIG. 8 is a cross-sectional view of the screw locked into a wood piece in the present invention.

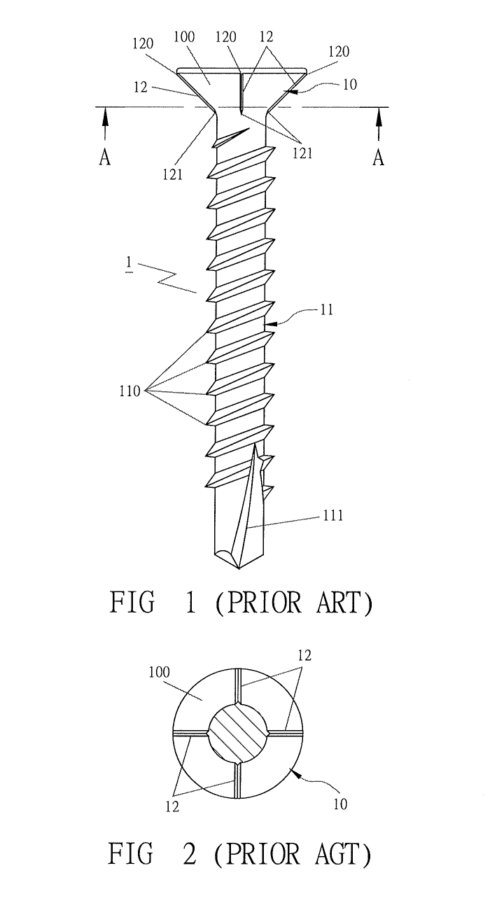

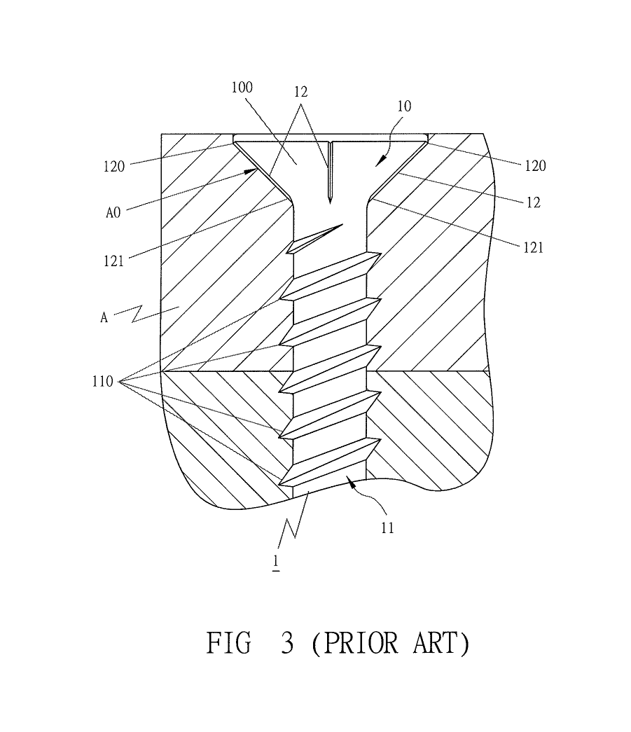

### DETAILED DESCRIPTION OF THE PREFERRED EMBODIMENT

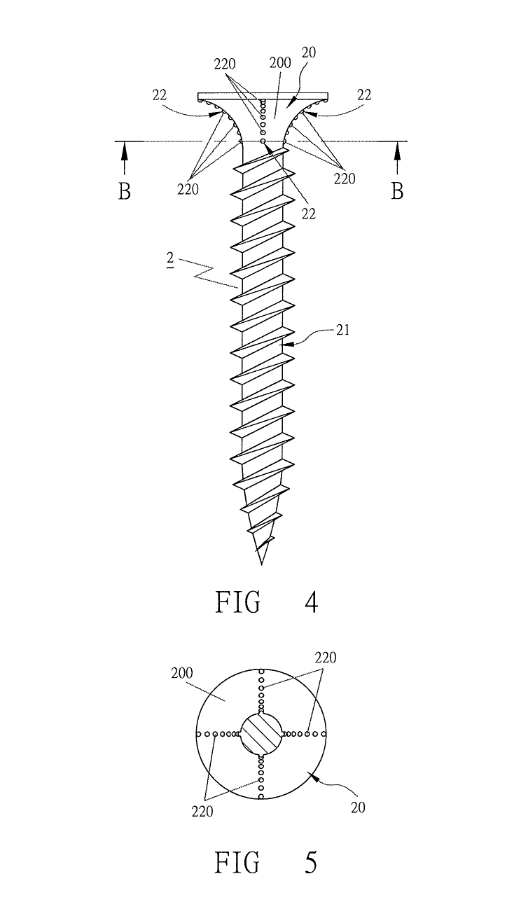

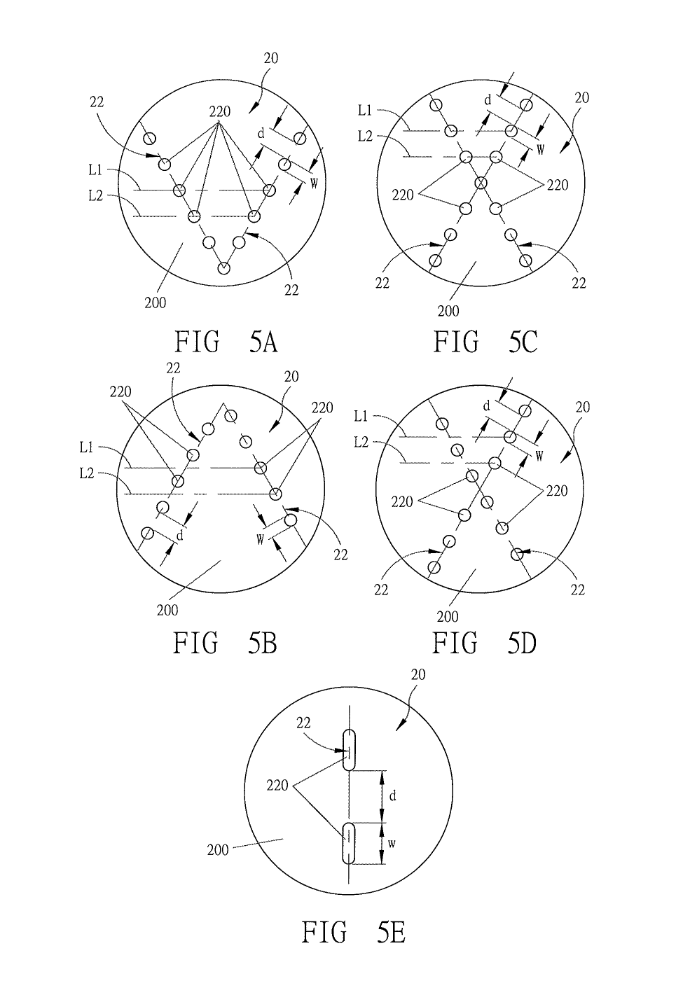

A preferred embodiment of a screw 2 in the present invention, as shown in FIGS. 4-5D, includes a head 20 and a shank 21.

The head 20 is provided with a circumference 200, which can be formed into various shapes, such as an arcuate shape shown in FIG. 4, or a conical shape shown in FIG. 7. The circumference 200 is provided thereon with a single rib 22 or plural ribs 22, and each rib 22 is composed of a plurality of dot projections 220 arranged continuously, as shown in FIG. 5. Between every two dot projections 220 is formed a distance (d) that can be smaller than or equivalent to or larger than the outer diameter (r) or the width (w) of the dot projections 220, and the dot projections 220 of two adjacent ribs 22 are arranged in a straight line as shown in FIGS. 5A and 5C, or arranged in a intercrossing condition, as shown in FIGS. 5B and 5D. If arranged in a straight line, the dot projections 220 of every two adjacent ribs 22 lie on a same basic line L1 or L2, and the rest can be done in the same manner, and if arranged in an intercrossing condition, the dot projections 220 of every two adjacent ribs 22 are not located on the same basic line L1 or L2, and the rest can be deduced accordingly, and each mode of arrangement mentioned above has its own advantages. When the dot projections 220 of every two adjacent ribs 22 are arranged in an intercrossing condition, the wood waste of a hole wall AO, which are not yet excavated by the dot projections 220 of the previous rib 22, will be continuously excavated and removed by the dot projections 220 of the latter ribs 22, thus enhancing locking velocity.

The ribs 22 on the circumference 200 can be provided in a straight line, as shown in FIGS. 4 and 5, or in a V shape or an inverted-V shape or a triangular shape, as shown in FIGS. 5A and 5B, or in an intersecting X-shape, as shown in FIGS. 5C and 5D. In other words, the ribs 22 formed on the circumference 200 of the head 20 can be formed into various types so long as they can function to excavate a wood piece and remove wood waste.

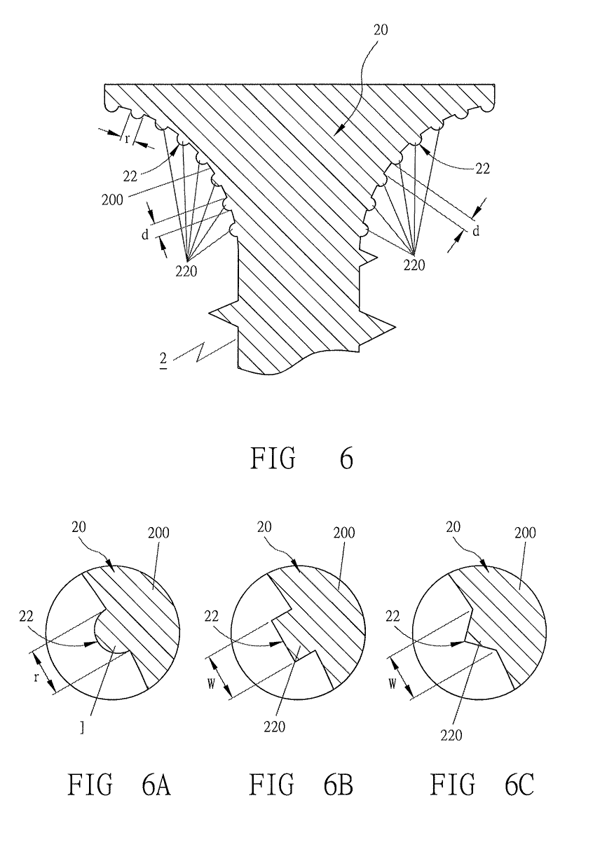

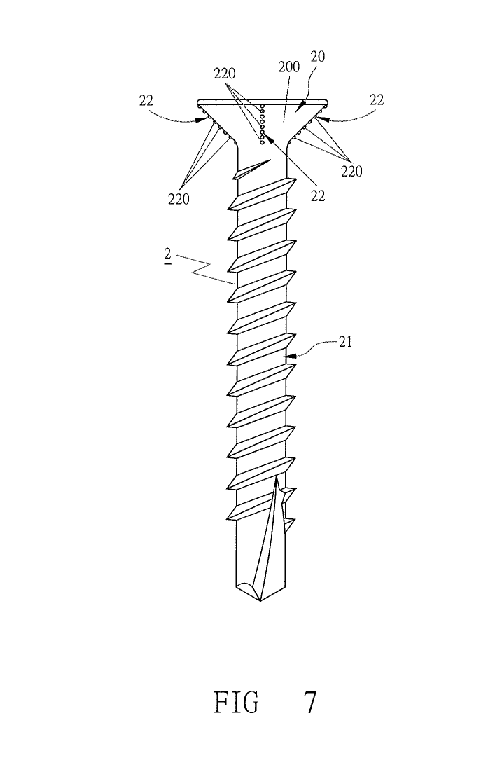

In addition, the dot projections 220 of the ribs 22 can be formed into an arcuate shape or an oval shape, as shown in FIGS. 6 and 6A, a square shape or a rectangular shape, as shown in FIGS. 5E and 6B, or a tapered shape or a conical shape as shown in FIG. 6C, that is to say, the rib members 220 of the ribs 22 can be made into various shapes so long as they can function to excavate a wood piece and remove wood waste.

Further, the screw 2 of this invention can be applied to a wood screw or a self-tapping screw, which has a head provided with a circumference 200 and which makes use of ribs 22 for excavating a wood piece and removing wood waste.

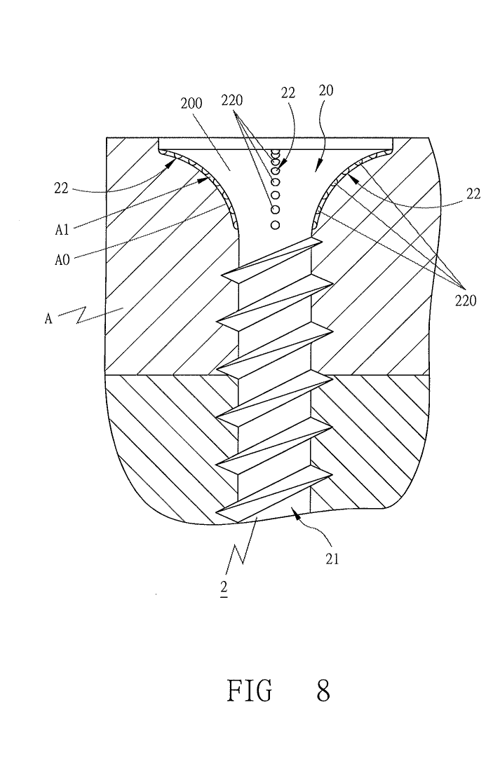

Referring to FIG. 8, when the screw 2 of this invention is used for locking a wood piece (A) and makes use of the ribs 22 on the circumference 200 of the head 20 to excavate the surface of the wood piece (A) and form a hole Al that matches with the circumference 200, the dot projections 220 will function to carry out excavating toward the hole wall AO of the wood piece (A). Since the dot projections 220 of each rib 22 are arranged continuously, it is able to lower contact resistance between the rib 22 and the hole wall AO of the hole Al of the wood piece (A). Moreover, the wood waste of the hole wall AO of the wood piece (A), which is not completely excavated and removed by the dot projections 220 of the previous rib 22, will be excavated and removed by the dot projections 220 of the latter rib 22. By so designing, the screw 2 of this invention can be locked into a wood piece with quickness.

While the preferred embodiment of the invention has been described above, it will be recognized and understood that various modifications may be made therein and the appended claims are intended to cover all such modifications that may fall within the spirit and scope of the invention.

What is claimed is:

1. A screw at least comprising:
A head and a shank, said head formed with a circumference, said circumference provided thereon with ribs, each said rib composed of plural dot projections arranged continuously, a distance (d) formed between every adjacent two of said dot projections of each same said rib, said distance being smaller than or equivalent to or larger than an outer diameter or a width of said rib member, said rib producing excavating effect when said circumference is being locked into a wood piece, said ribs enabling said screw to be locked into a wood piece comparatively easily.

2. The screw as claimed in claim 1, wherein said circumference of said head can be formed into various shapes.

3. The screw as claimed in claim 2, wherein said circumference of said head is arc-shaped.

4. The screw as claimed in claim 2, wherein said circumference of said head is taper-shaped.

5. The screw as claimed in claim 1, wherein said rib fixed on said circumference of said head is a single one or plural ones.

6. The screw as claimed in claim 1, wherein each said rib on said circumference of said head is made up of a plurality of dot projections.

7. The screw as claimed in claim 1, wherein said rib members of every adjacent two of said ribs on said circumference of said head are arranged in various forms.

8. The screw as claimed in claim 7, wherein said dot projections of every adjacent two of said ribs on said circumference of said head are arranged in a straight line, letting said dot projections of adjacent two of said ribs lie on a same basic line.

9. The screw as claimed in claim 7, wherein said dot projections of adjacent two of said ribs on said circumference of said head are arranged in an intercrossing condition, said dot projections of adjacent two of said ribs being not located on a same basic line.

10. The screw as claimed in claim 1, wherein said ribs on said circumference of said head are provided in various forms.

11. The screw as claimed in claim 10, wherein said ribs on said circumference of said head is provided in a straight line, in a V shape, in an inverted-V shape, in a triangular shape or in an intersecting X shape.

12. The screw as claimed in claim 1, wherein said rib members of said rib on said circumference of said head is formed into various shapes.

13. The screw as claimed in claim 12, wherein said dot projections of said rib on said circumference of said head are arc-shaped, oval-shaped, square-shaped, rectangle-shaped or taper-shaped.

14. The screw as claimed in claim 1, wherein said dot projections of said ribs on said circumference are arranged continuously, and said dot projections of adjacent two of said ribs function to carry out point excavating first and then surface excavating for lowering contact resistance between said ribs and walls of excavated holes of a wood piece.
